(19) United States
(12) Patent Application Publication
(10) Pub. No.: US 2008/0175107 A1
(43) Pub. Date: Jul. 24, 2008

(54) FOCUSING CONTROL METHOD FOR READING/WRITING OPTICAL DISC

(75) Inventors: Maarten Kuijper, Eindhoven (NL); Stefan Geusens, Eindhoven (NL); Wei-Chih Lin, Taipei (TW)

Correspondence Address: WPAT, PC, 7225 BEVERLY ST., ANNANDALE, VA, 22003, US

(73) Assignee: PHILIPS & BENQ DIGITAL STORAGE CORPORATION, Taipei (TW)

(21) Appl. No.: 11/624,795

(22) Filed: Jan. 19, 2007

(51) Int. Cl. G11B 7/00

(52) U.S. Cl. 369/44.23

(57) ABSTRACT

An optical reading/writing apparatus has an optical head that includes a collimator and a lens. For focusing control, a startup procedure is executed to generate a first startup S-curve. A boundary is then set according to the startup S-curve. After executing focusing on and tracking on, a plurality of position combinations of the collimator and the lens are selected for focusing calibration, thereby obtaining respective focusing error signals. By comparing the focusing error signals with the boundary, whether the position combinations of the selected collimator and the lens are valid can be determined. One of the valid position combinations with the greatest image-quality value is then selected to read/write the optical disc in the subsequent reading/writing procedure.

### FIELD OF THE INVENTION

The present invention relates to a focusing control method, and more particularly to a focusing control method for use in an optical disc drive to read/write an optical disc.

### BACKGROUND OF THE INVENTION

For reading/writing data from/to an optical disc, the optical head is moved in two directions, i.e. a direction perpendicular to the disc face, which is referred to as a focusing direction, and a direction parallel to the disc face, which is referred to as a tracking direction. Meanwhile, the light emitted by a light source such as a laser diode is focused by an object lens of the optical head on the optical disc, and the light reflected by the optical disc is transmitted to a light sensor to extract data. According to the obtained data, focusing error signal FE and tracking error signal TE can be realized for further adjusting the movement of the optical head in the focusing direction and the tracking direction.

To find the perfect focusing position by using the focusing error signal, a variety of methods such as astigmatic method, spot-size method, Foucault method, etc. can be employed for focusing control. Hereinafter, an astigmatic method is described in more detail as a focusing control example for better understanding. For implementing the astigmatic method, the optical sensor of an optical disc drive includes four light receiving parts A, B, C and D for respectively receiving the main beam reflected from the disc, as can be seen in any of FIGS. 1(a)˜1(c). As far as a focusing operation is concerned, the focusing error signal FE is substantially a difference between the summation of the overall light intensity received by the receiving parts A and C and the summation of the overall light intensity received by the receiving parts B and D, i.e. (A+C)−(B+D), where A, B, C and D are light intensities received by the regions A, B, C and D, respectively. FIGS. 1(a)˜1(c) illustrate three kinds of focusing results. When the light emitted by the light source is perfectly focused on the desired point, as shown in FIG. 1(b), the overall light intensity received by the receiving parts B and D will be equal to that the overall light intensity received by the receiving parts A and C, i.e. FE=(A+C)−(B+D)=0. In another case shown in FIG. 1(a), the value of (A+C)−(B+D) is minus, which indicates a focusing position above the perfect position. On the other hand, in the case shown in FIG. 1(c), the positive value of (A+C)−(B+D) indicates a focusing position below the perfect position. The relationship between the voltage of the focusing error signal FE and the depth of the focusing position (or the distance of the focusing position from the lens), which is so-called as “S-curve”, is illustrated in FIG. 1(d). The astigmatic method is performed in a closed-loop focusing control manner to zero the focusing error signal FE, thereby locating the perfect focusing position.

With the advancement of optical recording techniques, a variety of optical discs are developed for different applications. A Blu-ray disc is one of the newly developed optical discs. Blue-violet laser is used to read/write data from/to the Blu-ray disc. Due to the short wavelength of the blue-violet laser, e.g. 405 nm, more data can be stored in a Blu-ray disc than in a common red-laser optical disc accessed with about 650 nm wavelength. Due to the increased data quantity for a Blu-ray disc, high focusing precision is particularly required.

### SUMMARY OF THE INVENTION

The present invention provides a focusing control method for improving the focusing precision with high focusing efficiency.

The present invention relates to a focusing control method for use in an optical reading/writing apparatus to read/write an optical disc. The optical reading/writing apparatus has an optical head that includes a disc-cover or disc-substrate thickness compensating element and an objective lens. To compensate spherical aberration resulting from mismatch between the rigid objective lens and disc thickness variations several solutions are provided. Examples include an actuated collimation lens or so-called collimator, a LC-cell, or an actuated telescope design. For simplifying purpose, it is briefly indicated that the optical head includes a collimator and a lens. The focusing control method includes steps of: executing a startup procedure to generate a first startup S-curve; setting a boundary according to the startup S-curve; selecting a plurality of position combinations of the collimator and the lens for focusing calibration, thereby obtaining respective focusing error signals; determining whether the position combinations of the selected collimator and the lens are valid by comparing the focusing error signals with the boundary; and selecting one of the valid position combinations with the greatest image-quality value to read/write the optical disc.

In an embodiment, the first startup S-curve is generated by moving the lens within a movable range while fixing the collimator at a first position.

In an embodiment, more than one startup S-curve can be generated in the startup procedure. For example, a second startup S-curve is generated in the startup procedure by moving the lens within the movable range of the lens while fixing the collimator at an upper limit of a movable range of the collimator, and a third startup S-curve is generated in the startup procedure by moving the lens within the movable range of the lens while fixing the collimator at a lower limit of the movable range of the collimator. In another example, the optical disc is a dual-layer optical disc, so two consecutive startup S-curves are generated in the startup procedure.

In an embodiment, the boundary is set according to the smallest one of the maximum peaks of the startup S-curves and the largest one of the minimum peaks of the startup S-curves.

In an embodiment, the boundary has an upper margin that is a preset percentage, e.g. 60%, of a maximum peak value of the startup S-curve, and a lower margin that is a preset percentage, e.g. 60%, of a minimum peak value of the startup S-curve.

In an embodiment, any of the selected position combinations of the collimator and the lens is determined valid and subjected to an image-quality value calculation to obtain an image-quality value if the focusing error signal thereof lies within the boundary. On the other hand, any of the selected position combinations of the collimator and the lens is discarded from the image-quality value calculation if the focusing error signal thereof is beyond the boundary.

In an embodiment, the image-quality value is a wobble amplitude or jitter.

In an embodiment, the focusing calibration is executed after a focusing-on and tracking-on procedure.

### BRIEF DESCRIPTION OF THE DRAWINGS

The above contents of the present invention will become more readily apparent to those ordinarily skilled in the art after reviewing the following detailed description and accompanying drawings, in which:

FIGS. 1(a), 1(b) and (c) are diagrams schematically illustrating three possible situations of a focusing error signal FE generated according to an astigmatic method;

FIG. 1(d) is a waveform diagram schematically illustrating focusing error signal FE variations with focusing positions (S-curve) when focusing on a single-layer disc according to the astigmatic method;

FIG. 2 is a schematic diagram showing the means for processing laser rays according to the present invention;

FIG. 3 is a contour diagram illustrating the wobble amplitude measurement correlating to focusing offset and spherical aberration;

FIG. 4 is a flowchart illustrating a focusing control method according to an embodiment of the present invention; and

FIG. 5 is a schematically illustrating focusing error signal FE variations with focusing positions (S-curve) when focusing on a dual-layer disc according to the astigmatic method.

### DETAILED DESCRIPTION OF THE PREFERRED EMBODIMENT

Due to the spherical shape of the lens of an optical head, the focusing of the lens would be less than ideal. Therefore, spherical aberration, which is some kind of image imperfection that occurs due to the increased refraction of the laser rays that occurs when rays strike the lens near its edge, would be rendered. To remedy the spherical aberration, a collimator is introduced upstream of a lens of the optical head to filter the rays so that only those traveling parallel to a specified direction can pass through.

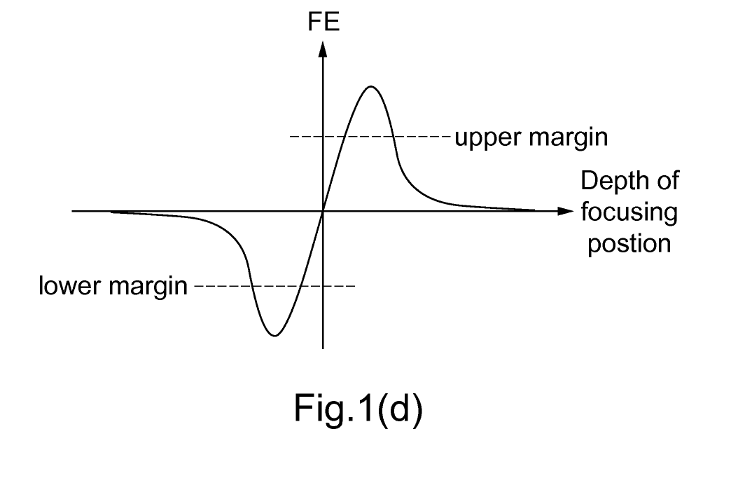

For compensating spherical aberration as well as focusing offset, a collimator is combined with a lens to be included in an optical head of an optical reading/writing apparatus such as a CD, DVD, Blu-ray and HD-DVD. Please refer to FIG. 2 which schematically exemplifies the laser rays emitted by a laser diode 20 and processed by a collimator 21 and a lens 22 to be well focused on an optical disc 23. As shown, parallel laser rays are obtained through the collimator 21 so as to be precisely focused on the optical disc 23 by the lens 22.

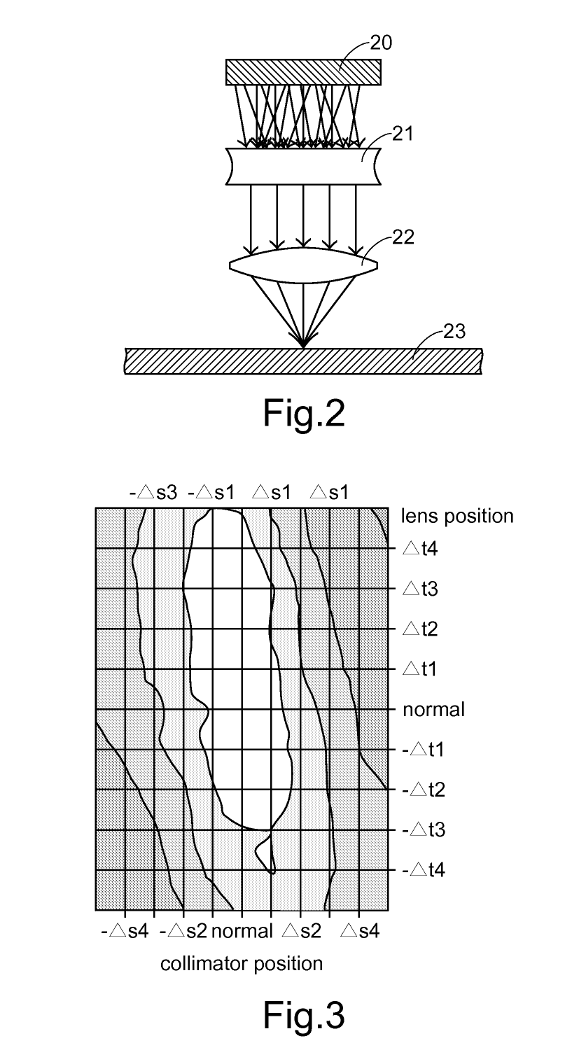

Due to the introduction of collimator 21, simply realizing focusing error signal FE information is insufficient for locating the optimal focusing position of the optical head. Accordingly, the collimator 21 and lens 32 are both adjusted to locate the optimum focusing position on the optical disc 23. With the movement of the collimator 21 and lens 22, the summation of the overall light intensities received by the receiving parts A, B, C and D of the optical head changes. Accordingly, the wobble amplitudes (or jitters) specific to the optical disc 23 can be measured and obtained as shown in FIG. 3. The different grey levels indicate different ranges of wobble amplitudes or jitters. It is to be noted that the coordinates of the contour diagram as depicted in FIG. 3 are positions of the collimator and lens, wherein Δt indicates the shift of the lens from the normal position of the lens and As indicates the shift of the collimator from the normal position of the collimator. In practice, however, the wobble amplitudes (or jitters) are expressed as a function of spherical aberration relevant to the position change of the collimator and focusing offset relevant to the position change of the lens. Usually, the algorithm repeatedly changes the focusing offset until a sufficient wide dynamic range is found containing or predicting the optimum value. Sometimes the focusing offset is set to such a large value that the servo loses focus. That invokes a focusing recovery. With too many recoveries, focusing offset optimization would fail. Also with a too large focus-offset normal playback and recording become unacceptably unstable. Therefore, these recoveries should be prevented as much as possible. According to the present invention, a boundary is set to reduce the focusing recoveries.

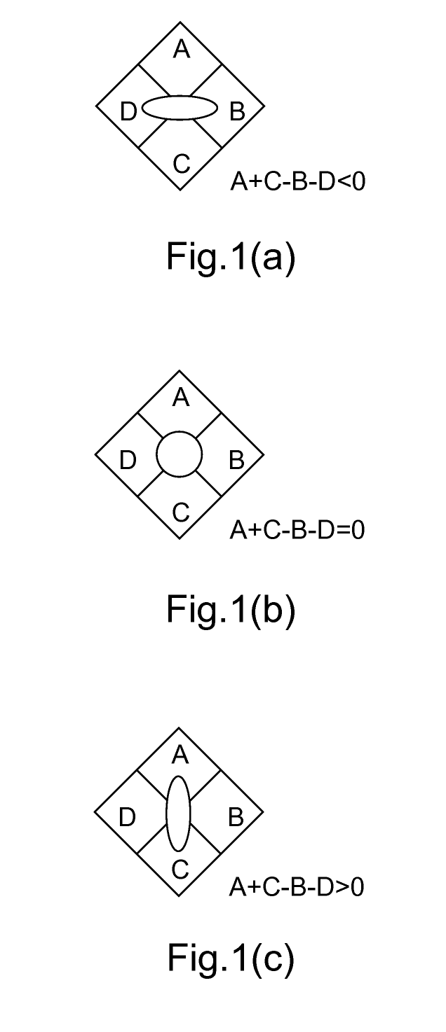

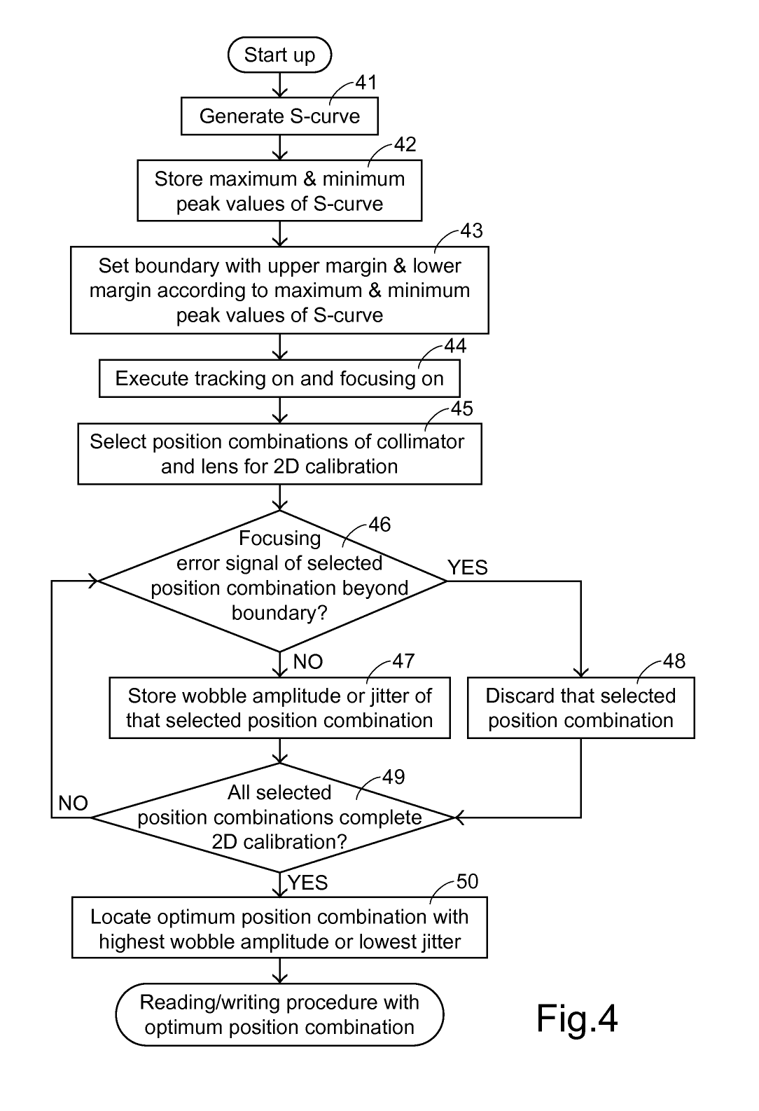

Please refer to FIG. 4, which is a flowchart illustrating a focusing control method for a combination of collimator and lens according to an embodiment of the present invention. First of all, a startup procedure is executed with the unmoved collimator and the moving lens to obtain a startup S-curve (Step 41). According to the startup S-curve, values of a maximum peak and a minimum peak are realized and stored (Step 42). Set an upper margin and a lower margin according to the maximum peak and the minimum peak of the S-curve, respectively (Step S43). For example, the values of the upper margin and the lower margin are 60% of the values of the maximum peak and the minimum peak, respectively, as illustrated in FIG. 1(d). Then, execute tracking on and focusing on based on the S-curve to approach the focusing and tracking positions (Step 44). Afterwards, a 2D (two-dimensional) calibration procedure are executed at selected position combinations of the collimator and lens (Step 45). For example, the collimator is first fixed at a preset position with normal spherical aberration while moving the lens to a plurality of preset positions around normal focusing offset, then the collimator is moved to next preset position accompanied by the movement of the lens to those preset positions, and so on. Alternatively, it can be the lens fixed at a preset position with normal focusing offset first while moving the collimator to a plurality of preset positions around normal spherical aberration, and then likewise, the lens is moved to next preset position with the collimator moving to those preset position, and so on. The normal positions of the collimator and the lens can be information preset in the apparatus, e.g. at the middle point of the movable range, or obtained in the startup procedure, e.g. with minimum focusing offset and spherical aberration.

For each position combination of the collimator and lens, a focusing error signal FE is realized. The focusing error signal FE is compared with the values of the upper margin and the lower margin of the startup S-curve (Step 46). If the focusing error signal FE lies between the upper margin and the lower margin, the corresponding wobble amplitude or jitter can be realized according to the response level (A+B+C+D) (Step 47). On the contrary, if the focusing error signal FE is beyond the boundary, the corresponding position combination of the collimator and the lens will be discarded from the candidates of the optimal focusing position (Step 48). In other words, it is not necessary to measure the wobble amplitude or jitter for that position combination, so the calibration efficiency can be improved and the undesired focusing recovery can be avoided. After all the wobble amplitudes or jitters of those valid position combinations of the collimator and the lens are obtained (Step 49), an optimal focusing position combination of the collimator and the lens, which has the highest wobble amplitude or lowest jitter, can be obtained accordingly and used in subsequent reading/writing procedure (Step 50).

In the embodiment illustrated with the flowchart of FIG. 4, the boundary of focusing error signal FE is determined according to a single S-curve that is obtained by fixing the collimator at a normal position. In another embodiment of the present invention, more than one S-curve can be obtained by changing the positions of the collimator. For example, by fixing the collimator at a normal position while moving the lens to obtain a first S-curve, then moving the collimator to an upper limit and fixing the collimator at the limit position while moving the lens to obtain a second S-curve, and then moving the collimator to the opposite lower limit and fixing the collimator at the limit position while moving the lens to obtain a third S-curve. Compare the S-curves, use the smallest one of the three maximum peaks of the three S-curves as the maximum peak value for determining the upper margin, and use the largest one of the three minimum peaks of the three S-curves as the minimum peak value for determining the lower margin. The resulting upper margin and lower margin are then used to screen position combinations of collimator and lens as illustrated in FIG. 4.

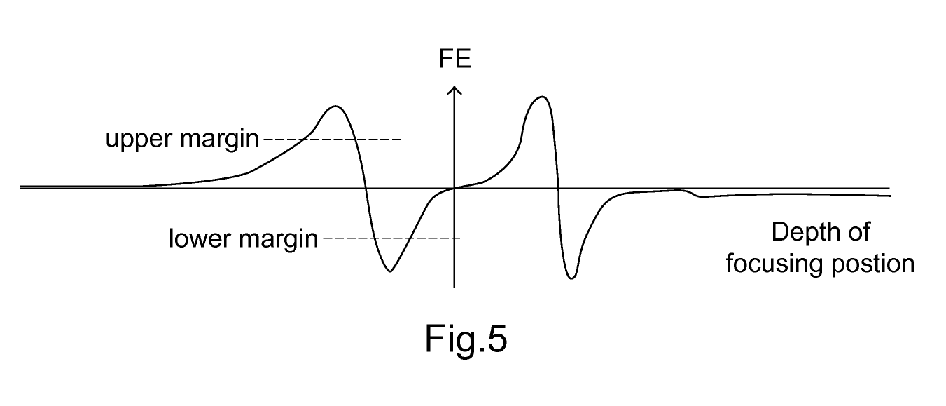

The present method can also be applied to a focusing control method for reading/writing a dual-layer disc. As known to those ordinary in the art, two consecutive S-curves will be obtained for a dual-layer disc, as shown in FIG. 5. Accordingly, the smaller one of the two maximum peaks of the two S-curves is used as the maximum peak value for determining the upper margin, and the larger one of the two minimum peaks of the two S-curves is used as the minimum peak value for determining the lower margin. The resulting upper margin and lower margin are then used to screen position combinations of collimator and lens as illustrated in FIG. 4. In a further embodiment, the S-curves obtained at different collimator positions are used for determining the upper and lower margins. For example, by fixing the collimator at a normal position while moving the lens to obtain first S-curves of the dual-layer disc, then moving the collimator to a limit and fixing the collimator at the limit position while moving the lens to obtain second S-curves of the dual-layer disc, and then moving the collimator to the opposite limit and fixing the collimator at the limit position while moving the lens to obtain third S-curves of the dual-layer disc. Compare the S-curves, use the smallest one of the six maximum peaks of the first, second and third S-curves as the maximum peak value for determining the upper margin, and use the largest one of the six minimum peaks of the first, second and third S-curves as the minimum peak value for determining the lower margin. The resulting upper margin and lower margin are then used to screen position combinations of collimator and lens as illustrated in FIG. 4.

In this way, the recovery problems can be eliminated so as to improve the reading/writing performance. Moreover, the focusing precision on a high-capacity optical disc such as BD-R or BD-RE disc can be improved.

Although the present invention has been described above with reference to (a) specific embodiment(s), it is not intended to be limited to the specific form set forth herein. Rather, the invention is limited only by the accompanying claims and, other embodiments than the specific above are equally possible within the scope of these appended claims, e.g. different systems than those described above, like for example the Foucault or knife-edge method and spot-size method. In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

What is claimed is:

1. A focusing control method for use in an optical reading/writing apparatus to read/write an optical disc, the optical reading/writing apparatus having an optical head that includes a collimator and a lens, and the focusing control method comprising steps of:
executing a startup procedure to generate a first startup S-curve;
setting a boundary according to the startup S-curve;
selecting a plurality of position combinations of the collimator and the lens for focusing calibration, thereby obtaining respective focusing error signals;
determining whether the position combinations of the selected collimator and the lens are valid by comparing the focusing error signals with the boundary; and
selecting one of the valid position combinations with the greatest image-quality value to read/write the optical disc.

2. The focusing control method according to claim 1 wherein the first startup S-curve is generated by moving the lens within a movable range while fixing the collimator at a first position.

3. The focusing control method according to claim 2 wherein more than one startup S-curve are generated in the startup procedure.

4. The focusing control method according to claim 3 wherein a second startup S-curve is generated in the startup procedure by moving the lens within the movable range of the lens while fixing the collimator at an upper limit of a movable range of the collimator, and a third startup S-curve is generated in the startup procedure by moving the lens within the movable range of the lens while fixing the collimator at a lower limit of the movable range of the collimator.

5. The focusing control method according to claim 3 wherein the optical disc is a dual-layer optical disc, and two consecutive startup S-curves are generated in the startup procedure.

6. The focusing control method according to claim 3 wherein the boundary is set according to the smallest one of the maximum peaks of the startup S-curves and the largest one of the minimum peaks of the startup S-curves.

7. The focusing control method according to claim 1 wherein the boundary has an upper margin that is a preset percentage of a maximum peak value of the startup S-curve, and a lower margin that is a preset percentage of a minimum peak value of the startup S-curve.

8. The focusing control method according to claim 7 wherein the upper margin is 60% of the maximum peak value, and the lower margin is 60% of the minimum peak value.

9. The focusing control method according to claim 1 wherein any of the selected position combinations of the collimator and the lens is determined valid and subjected to an image-quality value calculation to obtain an image-quality value if the focusing error signal thereof lies within the boundary.

10. The focusing control method according to claim 9 wherein any of the selected position combinations of the collimator and the lens is discarded from the image-quality value calculation if the focusing error signal thereof is beyond the boundary.

11. The focusing control method according to claim 1 wherein the image-quality value is a wobble amplitude or jitter.

12. The focusing control method according to claim 1 wherein the focusing calibration is executed after a focusing-on and tracking-on procedure.
